(19) United States
(12) Patent Application Publication
(10) Pub. No.: US 2005/0127815 A1
(43) Pub. Date: Jun. 16, 2005

(54) Electro luminescent with a color changing coating

(76) Inventor: Chin Yuan Wang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/731,098

(22) Filed: Dec. 10, 2003

(51) Int. Cl. H01J 63/04; H01J 1/62

(52) U.S. Cl. 313/498

(57) ABSTRACT

An electro luminescent (EL) with a color changing coating includes a transparent base layer and a transparent front electrode layer piled up the base layer. The front electrode layer is electrically connected to a driving circuit. A lighting layer is piled up the front electrode layer. The lighting layer includes multiple lighting particles arranged therein. Each lighting particle has an outer periphery fully coated with an optical transform layer for changing a color of light ray from the lighting particle. An induce layer is piled up the lighting layer and a back electrode layer is piled up the induce layer. The back electrode layer is electrically connected to the driving circuit. An insulating layer coats the lighting layer, the induce layer and the back electrode layer.

### BACKGROUND OF THE INVENTION

1. Field of the Invention

The present invention relates to an electro luminescent, and more particularly to an electro luminescent with a color changing coating.

2. Description of Related Art

As usual, an electro luminescent (EL) directly transforms an electric energy to a light energy that is usually used as a planar light source. The EL is slice-shaped and a backlight element.

A conventional EL in accordance with the prior art shown in FIG. 4 comprises a transparent base layer (81), a front electrode layer (82), a lighting layer (83) a induce layer (84), a back electrode layer (85) and a insulating layer (86) sequentially piled up one by one, wherein multiple lighting particle (831) are arranged in the lighting layer (83). The front electrode layer (82) and the back electrode layer (85) are respectively connected to an alternating current to make the lighting particles (831) light in the lighting layer (83).

The marked lighting particle (831) has the following colors: green, blue-green, blue, reddish and white. However, the white and the reddish particles have an unstable quality and a short using life such that the white and the reddish particles are less used. For getting the designate color, the colored ray from the lighting particles (831) needs to be changed. In the conventional method, the resin of the lighting layer (83) is mixed with dyes for getting the designate color lighting ray from the EL. However, the varieties of color of the lighting layer (83) are unstable due to the concentration of the dyes and the thickness of the lighting layer (83). Consequently, the quality of the EL is relatively unstable.

Furthermore, the use-rate of the dyes must be raised when the light ray of the EL in a certain level. As a result, too much dyes will reduce the penetrate ability of the light ray from the lighting particles (831) and the brightness of the lighting layer (83) such that the lighting effect of the EL is relatively reduced due to a Beer's Law.

The present invention has arisen to mitigate and/or obviate the disadvantages of the conventional EL.

### SUMMARY OF THE INVENTION

The main objective of the present invention is to provide an improved EL that includes a color transform apparatus.

To achieve the objective, the EL in accordance wit the present invention comprises a transparent base layer and a transparent front electrode layer piled up the base layer. The front electrode layer is electrically connected to a driving circuit. A lighting layer is piled up the front electrode layer. The lighting layer includes multiple lighting particles arranged therein. Each lighting particle has an outer periphery fully coated with an optical transform layer for changing a color of light ray from the lighting particle. An induce layer is piled up the lighting layer and a back electrode layer is piled up the induce layer. The back electrode layer is electrically connected to the driving circuit. An insulating layer coats the lighting layer, the induce layer and the back electrode layer.

Further benefits and advantages of the present invention will become apparent after a careful reading of the detailed description with appropriate reference to the accompanying drawings.

### BRIEF DESCRIPTION OF THE DRAWINGS

FIG. 1 is cross-sectional view of an EL with a color changing coating in accordance with the present invention;

FIG. 2 is a cross-sectional view of a lighting particle of the EL in FIG. 1;

FIG. 3 is a cross-sectional view of a second embodiment of the lighting particle in accordance with the present invention; and

FIG. 4 is a cross-sectional view of a conventional EL in accordance with the prior art.

### DETAILED DESCRIPTION OF THE INVENTION

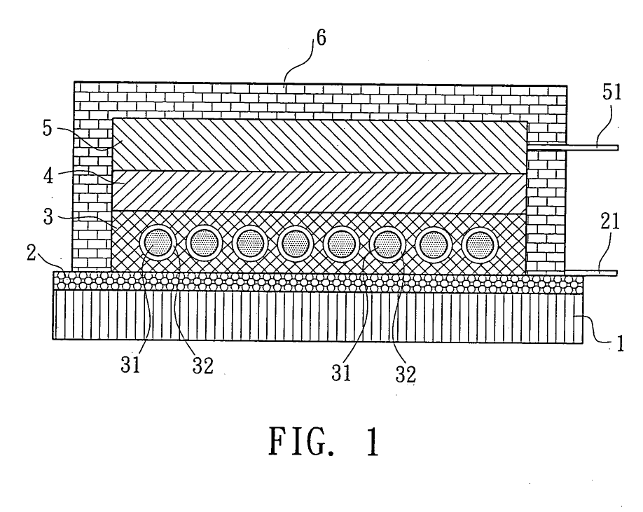

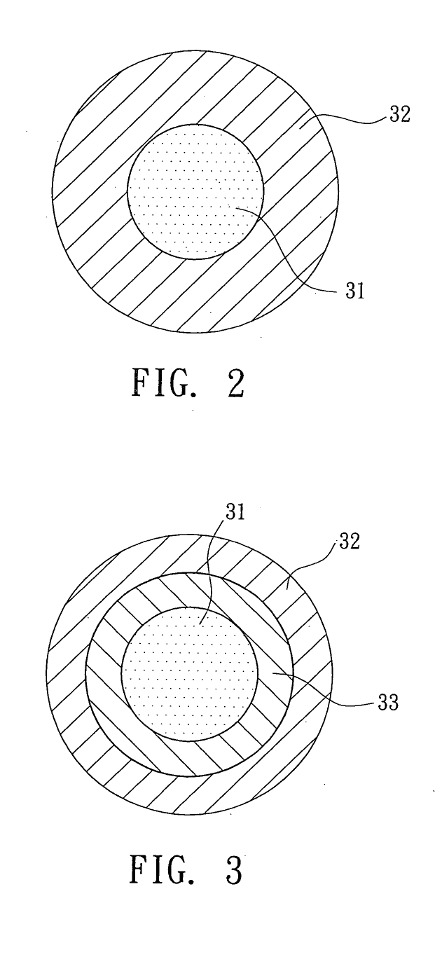

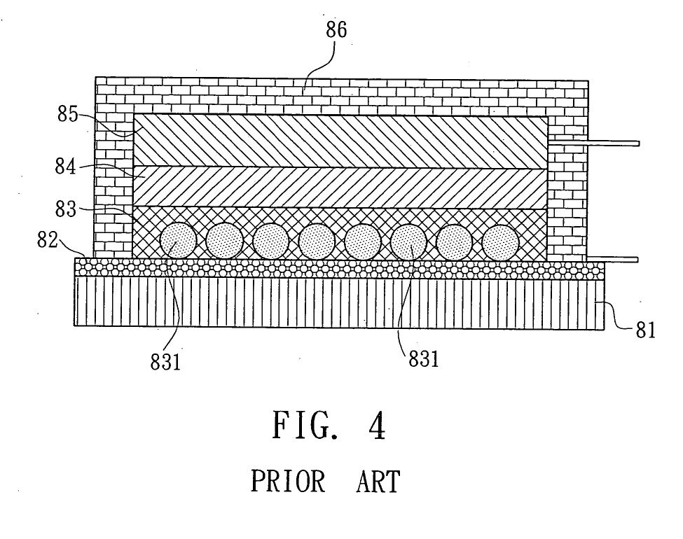

Referring to the drawings and initially to FIGS. 1-2, an EL with a color changing coating in accordance with the present invention comprises a base layer (1) and a front electrode layer (2) piled up the base layer (1). The base layer (1) and the front electrode layer (2) are transparent. In the preferred embodiment of the present invention, the front electrode layer (2) is a made of indium tin oxide (ITO). A lighting layer (3) is piled up the front electrode layer (2) and has multiple lighting particles (31) arranged in the lighting layer (3). An induce layer (4) is piled up the lighting layer (3) and a back electrode layer (5) piled up the induce layer (4). The lighting layer (3), the induce layer (4) and the back electrode layer (5) are coated with an insulating layer (6). The front electrode layer (2) has a terminal (21) extending therefrom and electrically connected to a driving circuit (not shown) and the back electrode layer (5) has a terminal (51) extending from the back electrode layer (5) through the insulating layer (6) and electrically connected to the driving circuit. Consequently, the EL lights when the electric current flows into the EL via the two terminals (21, 51) of the front electrode layer (2) and the back electrode layer (5).

The lighting layer (3) is printed on the front electrode layer (2) and each lighting particle (31) has an outer periphery fully coated with an optical transform layer (32) that is consisted of multiple dyeing materials. Consequently, the color of the light ray from the lighting particles (31) is changed due to the optical transform layer (32).

The optical transform layer (32) directly changes the color of the light ray from the lighting particle (31). Consequently, the lighting layer (3) does not need to be mixed with dyes. As a result, the color of light ray from the EL is stable, and the concentration of dyes and the thickness of the lighting layer (3) never influence the color of light ray from the EL. Furthermore, the penetrate ability of the light ray from the lighting particles (31) and the brightness of the lighting layer (3) is raised.

With reference to FIG. 3, a second embodiment of the lighting particle (31) is provided. As regard to the lighting particle (31) of the above embodiment, the outer periphery of the lighting particle (31) is fully coated with a protect layer (33) and the optical transform layer (32) fully coats with an outer periphery of the protect layer (33). The protect layer (33) can prevent the lighting particle (31) from contacting with mist or oxygen for elongating the using life of the lighting particle (31).

Although the invention has been explained in relation to its preferred embodiment, it is to be understood that many other possible modifications and variations can be made without departing from the spirit and scope of the invention as hereinafter claimed.

1. An electro luminescent (EL) with a color changing coating, comprising:
a base layer, the base layer being transparent;
a front electrode layer piled up the base layer, the front electrode layer being transparent, the front electrode layer electrically connected to a driving circuit;
a lighting layer piled up the front electrode layer, the lighting layer including multiple lighting particles arranged therein, each lighting particle having an outer periphery fully coated with an optical transform layer for changing a color of light ray from the lighting particle;
an induce layer piled up the lighting layer;
a back electrode layer piled up the induce layer, the back electrode layer electrically connected to the driving circuit; and
an insulating layer coating the lighting layer, the induce layer and the back electrode layer.

2. The EL as claimed in claim 1, wherein the lighting particle further comprises a protect layer disposed between the outer periphery of the lighting particle and the optical transform layer to prevent the lighting particle from contacting with mist and oxygen for elongating a using life of the lighting particle.

3. The EL as claimed in claim 1, wherein the optical transform layer is consisted of multiple dyeing materials.

4. The EL as claimed in claim 1, wherein the front electrode layer and the back electrode layer each comprises a terminal extending therefrom and respectively electrically connected to the driving circuit.

5. The EL as claimed in claim 2, wherein the optical transform layer is consisted of multiple dyeing materials.

6. The EL as claimed in claim 2, wherein the front electrode layer and the back electrode layer each comprises a terminal extending therefrom and respectively electrically connected to the driving circuit.

7. The EL as claimed in claim 3, wherein the front electrode layer and the back electrode layer each comprises a terminal extending therefrom and respectively electrically connected to the driving circuit.
